(19) United States
(12) Patent Application Publication
(10) Pub. No.: US 2020/0340821 A1
(43) Pub. Date: Oct. 29, 2020

(54) ROUTE GUIDANCE SYSTEM

(71) Applicant: TOYOTA JIDOSHA KABUSHIKI KAISHA, Toyota-shi (JP)

(72) Inventors: Shin SAKURADA, Toyota-shi (JP); Sinae KIM, Nagoya-shi (JP); Takayuki YANO, Nisshin-shi (JP); Naoki YAMAMURO, Nagoya-shi (JP); Takashi HAYASHI, Aichi-gun (JP); Koji MIYATA, Nagoya-shi (JP)

(73) Assignee: TOYOTA JIDOSHA KABUSHIKI KAISHA, Toyota-shi (JP)

(21) Appl. No.: 16/820,817

(22) Filed: Mar. 17, 2020

(30) Foreign Application Priority Data
Apr. 24, 2019 (JP) 2019-082458

(51) Int. Cl. G01C 21/36; G01C 21/34

(52) U.S. Cl. CPC G01C 21/3644; G01C 21/343; G01C 21/3682

(57) ABSTRACT

A route guidance system according to the present disclosure is a route guidance system in which a server device distributes route guidance information to a vehicle via a telecommunications line. The server device includes: a route guidance information database in which route guidance information is stored, the route guidance information including route information from a departure point to a destination for route guidance and pieces of image information on points included in the route information; and a route guidance information distribution portion configured to distribute, to the vehicle, the route guidance information stored in the route guidance information database in response to a transmission request from the vehicle.

### INCORPORATION BY REFERENCE

The disclosure of Japanese Patent Application No. 2019-082458 filed on Apr. 24, 2019 including the specification, drawings and abstract is incorporated herein by reference in its entirety.

### BACKGROUND

### 1. Technical Field

The present disclosure relates to a route guidance system in which a server device distributes route guidance information to a vehicle via a telecommunications line.

### 2. Description of Related Art

Japanese Unexamined Patent Application Publication No. 2005-37246 (JP 2005-37246 A) describes a car navigation device configured such that, when a user selects a sightseeing spot from a sightseeing spot list, video data of the sightseeing spot is displayed, and when the user selects and determines sightseeing spots that the user wants to visit, a route passing through the selected sightseeing spots is displayed based on a position of a vehicle that is detected by a GPS function, pieces of position data of the sightseeing spots, and road congestion information.

### SUMMARY

In the car navigation device described in JP 2005-37246 A, the route to the sightseeing spots selected by the user is determined by use of a general route search technique. However, in a case where the user does not know the selected sightseeing spots well, the user often does not know recommended spots in the middle of the route to the sightseeing spots either. On this account, in order to improve convenience of route guidance, it is considered to be effective to provide, to the user, route guidance information determined in consideration of recommended spots in the middle of the route to the selected sightseeing spots instead of determining the route to the sightseeing spots by use of the general route search technique.

The present disclosure is accomplished in view of the above problem, and an object of the present disclosure is to provide a route guidance system that can improve convenience of route guidance.

A route guidance system according to the present disclosure is a route guidance system in which a server device distributes route guidance information to a vehicle via a telecommunications line. The server device includes a route guidance information database and a route guidance information distribution portion. In the route guidance information database, route guidance information is stored. The route guidance information includes route information from a departure point to a destination for route guidance and pieces of image information on points included in the route information. The route guidance information distribution portion is configured to distribute, to the vehicle, the route guidance information stored in the route guidance information database in response to a transmission request from the vehicle.

Upon receipt of pieces of information on the departure point and the destination from the vehicle, the route guidance information distribution portion may search for route guidance information including the received pieces of information on the departure point and the destination. The route guidance information distribution portion may transmit, to the vehicle, the route guidance information thus found. With such a configuration, it is possible to distribute optimum route guidance information to each vehicle.

With the route guidance system of the present disclosure, a user can set a route to a destination while the user checks information about a point in the middle of a route to the destination based on image information. This makes it possible to improve convenience of route guidance.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view illustrating a configuration of a route guidance system according to one embodiment of the present disclosure;

FIG. 2 is a block diagram illustrating a configuration of a vehicle illustrated in FIG. 1;

FIG. 3 is a block diagram illustrating a configuration of a server device illustrated in FIG. 1;

FIG. 4 is a view illustrating an example of route information stored in a route guidance information database illustrated in FIG. 3;

FIG. 5 is a timing chart illustrating the procedure of a route guidance process according to one embodiment of the present disclosure;

FIG. 6 is a schematic view illustrating an example of an operation screen of a navigation system; and

FIG. 7 is a schematic view illustrating a display example of route guidance information.

### DETAILED DESCRIPTION OF EMBODIMENTS

With reference to drawings, the following describes a configuration of a route guidance system according to one embodiment of the present disclosure.

Overall Configuration

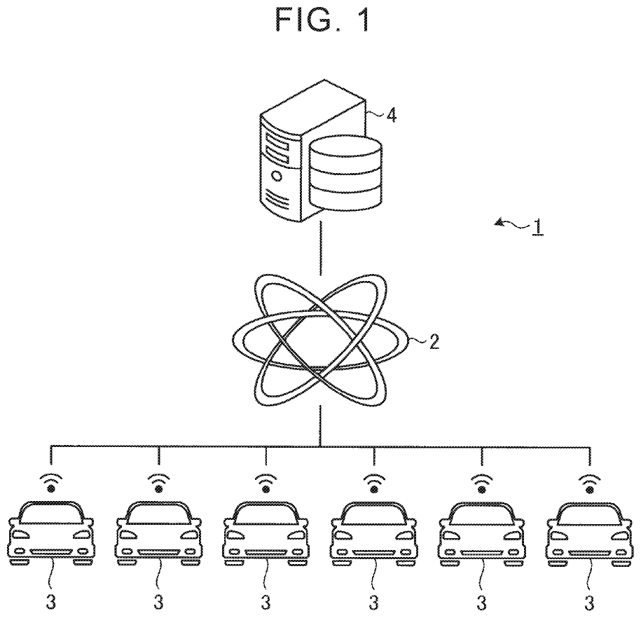

First described is an overall configuration of the route guidance system according to one embodiment of the present disclosure with reference to FIG. 1.

FIG. 1 is a schematic view illustrating the configuration of the route guidance system according to one embodiment of the present disclosure. As illustrated in FIG. 1, a route guidance system 1 according to one embodiment of the present disclosure is a system in which a server device 4 distributes route guidance information to a vehicle 3 via a telecommunications line 2 such as an Internet network or a mobile phone network. The route guidance system 1 includes a plurality of vehicles 3 and the server device 4 as main constituents.

Configuration of Vehicle

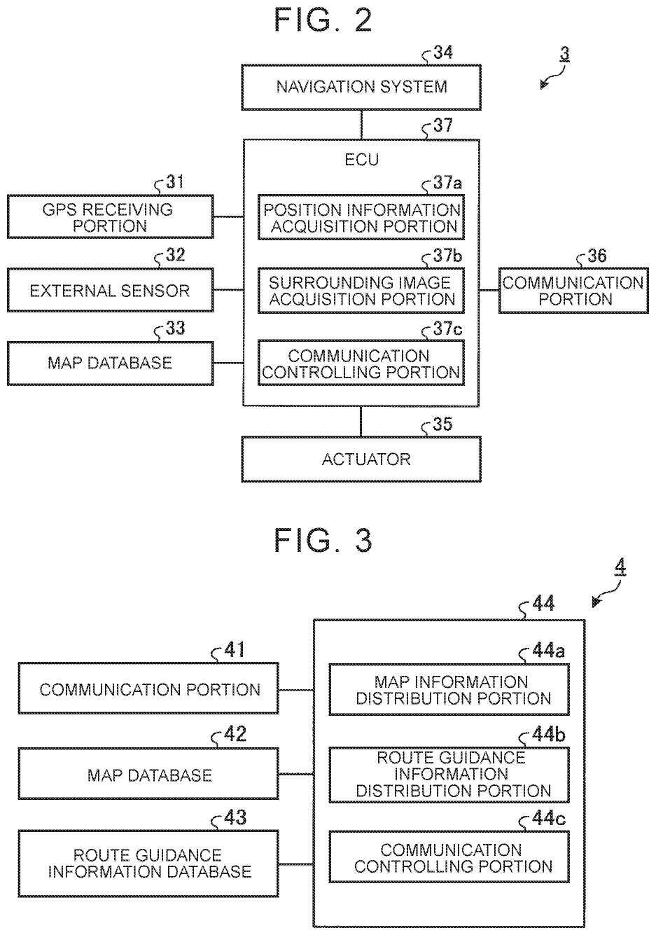

With reference to FIG. 2, the following describes a configuration of the vehicle 3.

FIG. 2 is a block diagram illustrating the configuration of the vehicle 3 illustrated in FIG. 1. As illustrated in FIG. 2, the vehicle 3 includes a global positioning system (GPS) receiving portion 31, an external sensor 32, a map database 33, a navigation system 34, an actuator 35, a communication portion 36, and an electronic control unit (ECU) 37.

The GPS receiving portion 31 functions as a position measuring portion configured to measure a position of the vehicle 3. The GPS receiving portion 31 measures the position of the vehicle 3 (e.g., latitude and longitude of the vehicle 3) by receiving signals from three or more GPS satellites. The GPS receiving portion 31 outputs information on the measured position of the vehicle 3 to the ECU 37. Note that the vehicle 3 may measure the position of the vehicle 3 by a simultaneous localization and mapping (SLAM) technology by use of position information on fixed obstacles such as power poles and a detection result from the external sensor 32. The position information on fixed obstacles is included in map information stored in the map database 33.

The external sensor 32 includes imaging devices, a radar, and a LIDAR. The imaging devices are imaging equipment configured to capture an image of a state outside the vehicle 3. The imaging devices are provided on a back side of a windshield of the vehicle 3 and a back face of the vehicle 3. The imaging devices may be provided on right and left side faces of the vehicle 3. The imaging devices output pieces of imaging information on captured images in front of and behind the vehicle 3 to the ECU 37. The imaging device may be a monocular camera or may be a stereoscopic camera. The stereoscopic camera has two imaging portions placed to reproduce binocular parallax. Imaging information of the stereoscopic camera also includes information in a depth direction.

The radar detects an obstacle around the vehicle 3 by use of radio wave (e.g., millimeter wave). The radar transmits a radio wave to a region around the vehicle 3 and detects an obstacle by receiving a radio wave reflected from the obstacle. The radar outputs obstacle information thus detected to the ECU 37. The obstacle includes a dynamic obstacle such as a bicycle or other vehicles, other than the fixed obstacles. The LIDAR detects an obstacle around the vehicle 3 by use of light. The LIDAR applies light to a region around the vehicle 3 and measures a distance to a reflection point by receiving light reflected from an obstacle, and thus, the LIDAR detects the obstacle. The LIDAR outputs obstacle information thus detected to the ECU 37. It is not always necessary for the external sensor 32 to include both the LIDAR and the radar.

The map database 33 is a database in which map information is stored. The map database 33 is formed in a storage device such as a hard disk drive (HDD) provided in the vehicle 3. The map database 33 can be connected to the server device 4 by wireless communication via the communication portion 36. The map database 33 regularly updates the map information by use of latest map information stored in the server device 4. The map information includes version information, position information on roads (position information of each lane), information on road shapes (e.g., types such as a curve and a linear part, a curvature of a curve, and so on), information on road widths (information on lane widths), information on limited speeds on roads, and image information around roads (three-dimensional information). Further, the map information includes position information on intersections and branch points, position information on temporary stop lines, position information on zebra zones, and position information on traffic lights. The map information may include information on road gradients and information on road cant. Further, the map information may include position information and shape information on fixed obstacles such as curb stones, power poles, poles, guard rails, walls, and buildings. The map information may include position information and shape information on road surface paint such as characters and marks drawn on road surfaces. The road surface paint may include manholes. The map information may include information on signboards provided above roads, and information on signs provided on roadsides.

Based on a destination set in advance, the position of the vehicle 3 that is measured by the GPS receiving portion 31, and the map information in the map database 33, the navigation system 34 calculates a target route from a current position of the vehicle 3 to the destination by a well-known technique and executes route guidance along the target route. The destination is set by an occupant of the vehicle 3 operating an input button (or a touch panel) provided in the navigation system 34.

The actuator 35 is a device configured to perform a travel control on the vehicle 3. The actuator 35 includes a throttle actuator, a brake actuator, and a steering actuator. The throttle actuator controls a supply amount (a throttle opening degree) of air to an engine in accordance with a control signal from the ECU 37 and controls driving force of the vehicle 3. Note that, in a case where the vehicle 3 is a hybrid vehicle, the driving force is controlled such that a control signal from the ECU 37 is input into a motor as a power source, in addition to the control on the supply amount of the air to the engine. In a case where the vehicle 3 is an electric vehicle, the driving force is controlled such that a control signal from the ECU 37 is input into a motor as a power source. The motors as the power sources in those cases constitute the actuator 35. The brake actuator controls a brake system in accordance with a control signal from the ECU 37 and controls braking force applied to wheels of the vehicle 3. The steering actuator controls driving of an assist motor in accordance with a control signal from the ECU 37. The assist motor is configured to control a steering torque in an electric power steering system.

The communication portion 36 is constituted by a radio communications circuit and so on for wireless communication and performs information communication with the server device 4 via the telecommunications line 2. The communication portion 36 may perform vehicle-to-vehicle communication with other vehicles that can perform vehicle-to-vehicle communication. Further, the communication portion 36 may perform road-to-vehicle communication with a roadside transmitter-receiver provided along a road.

The ECU 37 is an electronic control unit including a central processing unit (CPU), a read only memory (ROM), a random access memory (RAM), a controller area network (CAN) communication circuit, and so on. In the present embodiment, the ECU 37 loads a computer program stored in the ROM to the RAM and executes the computer program loaded in the RAM by the CPU. Hereby, the ECU 37 functions as a position information acquisition portion 37a, a surrounding image acquisition portion 37b, and a communication controlling portion 37c.

The position information acquisition portion 37a acquires information on the position of the vehicle 3 by use of the GPS receiving portion 31. The surrounding image acquisition portion 37b acquires surrounding images around the vehicle 3 by use of the external sensor 32. The communication controlling portion 37c controls information communication with the server device 4 via the telecommunications line 2.

Configuration of Server Device

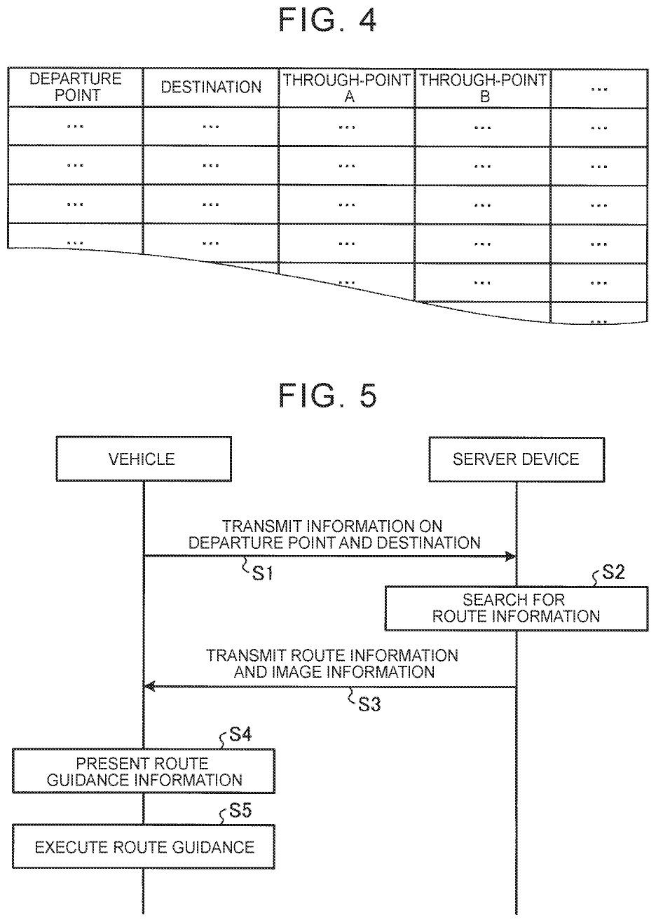

Next will be described a configuration of the server device 4 with reference to FIGS. 3 and 4. FIG. 3 is a block diagram illustrating the configuration of the server device 4 illustrated in FIG. 1. FIG. 4 is a view illustrating an example of route information stored in a route guidance information database 43 illustrated in FIG. 3.

As illustrated in FIG. 3, the server device 4 includes a communication portion 41, a map database 42, the route guidance information database 43, and a server device main body 44.

The communication portion 41 is constituted by a radio communications circuit and so on for wireless communication and performs information communication with the vehicle 3 via the telecommunications line 2.

The map database 42 is a database in which the map information is stored.

In the route guidance information database 43, information from a departure point to a destination for route guidance is stored as route guidance information. In the present embodiment, as illustrated in FIG. 4, the route guidance information includes route information including information on the departure point, information on the destination, and information on a plurality of points (through-points) to be passed between the departure point and the destination. Further, the route guidance information includes image information, video information, and text information for describing each point included in the route information. The route guidance information is generated, for example, by acquiring route guidance historical information of navigation systems 34 of other vehicles 3 via the telecommunications line 2 or by creating route guidance based on action histories of famous people.

The server device main body 44 is constituted by a well-known information processing device. When a processing unit inside the server device main body 44 executes computer programs, the server device main body 44 functions as a map information distribution portion 44a, a route guidance information distribution portion 44b, and a communication controlling portion 44c. The map information distribution portion 44a distributes the map information stored in the map database 42 to the vehicle 3 via the telecommunications line 2. The route guidance information distribution portion 44b distributes the route guidance information stored in the route guidance information database 43 to the vehicle 3 via the telecommunications line 2. The communication controlling portion 44c controls information communication with the vehicle 3 via the telecommunications line 2.

In the route guidance system 1 having the above configuration, the server device 4 executes a route guidance process described below, so that convenience of route guidance is improved. The following describes an operation of the server device 4 when the server device 4 executes the route guidance process, with reference to a timing chart illustrated in FIG. 5.

Route Guidance Process

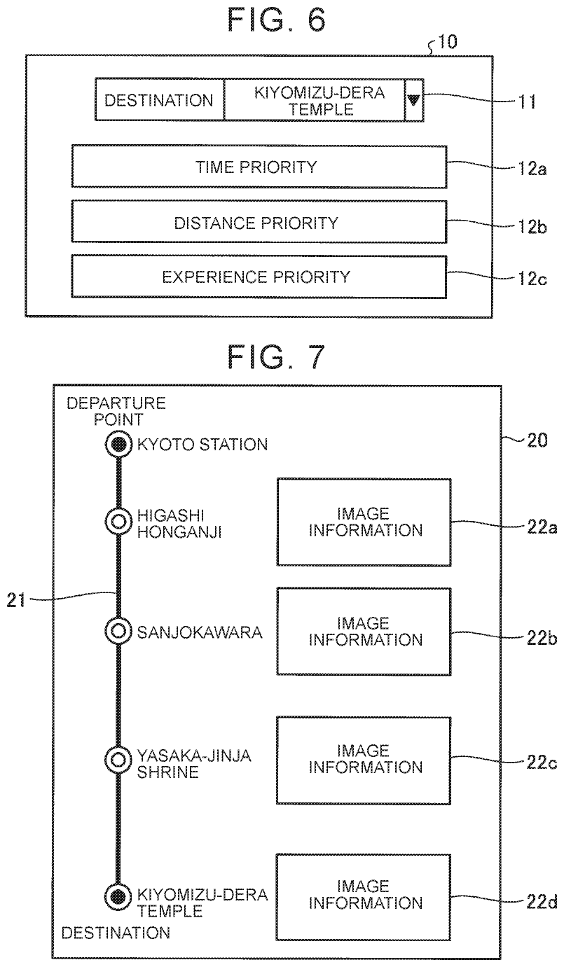

FIG. 5 is a timing chart illustrating the procedure of the route guidance process according to one embodiment of the present disclosure. The flowchart illustrated in FIG. 5 is started when a user inputs information on a destination into a destination window 11 on an operation screen 10 of the navigation system 34 as illustrated in FIG. 6 and selects an experience priority button 12c from priority condition setting buttons for route search. The priority condition setting buttons include a time priority button 12a, a distance priority button 12b, and the experience priority button 12c. Here, the route guidance process proceeds to a process of step S1. In a case where the time priority button 12a is selected, the navigation system 34 searches for a route that requires a shortest time from the starting point to the destination. In a case where the distance priority button 12b is selected, the navigation system 34 searches for a route that requires a shortest distance from the starting point to the destination.

In the process of step S1, the position information acquisition portion 37a acquires information on the current position of the vehicle 3 as information on the departure point of route guidance. Then, the communication controlling portion 37c transmits the information on the departure point that is acquired by the position information acquisition portion 37a and information on the destination input into the destination window 11 to the server device 4 via the telecommunications line 2. Hereby, the process of step S1 is completed, and the route guidance process proceeds to a process of step S2.

In the process of step S2, the route guidance information distribution portion 44b searches pieces of route information stored in the route guidance information database 43 for route information corresponding to the information on the departure point and the information on the destination that are transmitted from the vehicle 3. In a case where there is no route information corresponding to the information on the departure point and the information on the destination that are transmitted from the vehicle 3, the route guidance information distribution portion 44b may extract route information in which through-points correspond to the information on the departure point and the information on the destination. Hereby, the process of step S2 is completed, and the route guidance process proceeds to a process of step S3.

In the process of step S3, the route guidance information distribution portion 44b transmits, to the vehicle 3, route guidance information (the route information and image information) including the route information found in the process of step S2. Note that, at this time, the map information distribution portion 44a may read out map information around a point included in the route guidance information from the map database 42 and may distribute the map information thus read out to the vehicle 3. Further, the route guidance information distribution portion 44b may transmit, to the vehicle 3, different pieces of information on through-points for an outward path and a return path of a route that connects the departure point to the destination. Hereby, the process of step S3 is completed, and the route guidance process proceeds to a process of step S4.

In the process of step S4, the communication controlling portion 37c receives the route guidance information transmitted from the server device 4. As illustrated in FIG. 7, the navigation system 34 displays route information 21 and pieces of image information 22a to 22d on through-points and the destination on a display screen 20. The route information 21 and the pieces of image information 22a to 22d are included in the route guidance information. In the example illustrated in FIG. 7, the route information 21 heading from Kyoto Station to Kiyomizu-dera Temple via Higashi Honganji, Sanjokawara, and Yasaka-jinja Shrine is displayed together with the pieces of image information 22a to 22d indicative of Higashi Honganji, Sanjokawara, Yasaka-jinja Shrine, and Kiyomizu-dera Temple. Note that the pieces of image information 22a to 22d may be video information or text information. Further, in a case where there is a plurality of pieces of route information 21, the navigation system 34 sequentially displays each of the pieces of route information on the display screen 20. Further, in a case where the route guidance information thus displayed is created based on the action history of a famous person, the navigation system 34 may display that fact. Hereby, the process of step S4 is completed, and the route guidance process proceeds to a process of step S5.

In the process of step S5, the navigation system 34 executes route guidance based on the route guidance information selected and determined by the user. Hereby, the process of step S5 is completed, and a series of processes as the route guidance process is ended.

As is apparent from the above description, in the route guidance process according to one embodiment of the present disclosure, in a case where a user selects the experience priority button 12c on the operation screen 10 of the navigation system 34, the server device 4 distributes, to the vehicle 3, route guidance information including route information from a departure point to a destination for route guidance and pieces of image information on points included in the route information. The route guidance information is stored in the route guidance information database 43. With such a configuration, the user can set a route to the destination while the user checks information about a point in the middle of the route to the destination based on image information, thereby making it possible to improve convenience of route guidance. This also allows the user to take a trip to the same route as a famous person, for example. Thus, the user can re-experience a trip of the third party. This improves an entertainment aspect.

Further, in the route guidance process according to one embodiment of the present disclosure, upon receipt of pieces of information on a departure point and on a destination from the vehicle 3, the server device 4 searches for route guidance information including the received pieces of information on the departure point and the destination and transmits, to the vehicle, the route guidance information thus found. Thus, the server device 4 can distribute optimum route guidance information to each vehicle 3.

The embodiment to which the disclosure accomplished by the inventors is applied has been described above, but the present disclosure is not limited by descriptions and drawings as part of the disclosure of the disclosure in the present embodiment. That is, other embodiments, examples, application techniques, and so on made by a person skilled in the art and others based on the present embodiment are all included in the present disclosure.

What is claimed is:

1. A route guidance system in which a server device distributes route guidance information to a vehicle via a telecommunications line, wherein the server device includes:
a route guidance information database in which route guidance information is stored, the route guidance information including route information from a departure point to a destination for route guidance and pieces of image information on points included in the route information; and
a route guidance information distribution portion configured to distribute, to the vehicle, the route guidance information stored in the route guidance information database in response to a transmission request from the vehicle.

2. The route guidance system according to claim 1, wherein:
upon receipt of pieces of information on the departure point and the destination from the vehicle, the route guidance information distribution portion searches for route guidance information including the received pieces of information on the departure point and the destination; and
the route guidance information distribution portion transmits, to the vehicle, the route guidance information thus found.
